(19) United States
(12) Patent Application Publication
(10) Pub. No.: US 2025/0141131 A1
(43) Pub. Date: May 1, 2025

(54) CONNECTOR FOR ELECTRICAL BONDING

(71) Applicant: ECM Industries LLC, New Berlin, WI (US)

(72) Inventor: Matthew William Sweeney, Ringwood, IL (US)

(21) Appl. No.: 18/931,447

(22) Filed: Oct. 30, 2024

Related U.S. Application Data
(60) Provisional application No. 63/594,419, filed on Oct. 30, 2023.

(51) Int. Cl. H01R 11/07; H01R 4/36; H01R 11/01

(52) U.S. Cl. CPC H01R 11/07; H01R 4/36; H01R 11/01

(57) ABSTRACT

The disclosed technology can provide an improved connection system for multiple conductors. A grounding connector system can include a connector body with a main bonding receptacle and a secondary bonding receptable, to receive and provide an electrical connection between a first conductor and one or more second conductors. The secondary bonding receptacle can include tapered side walls or a substantially planar area.

### CROSS-REFERENCE TO RELATED APPLICATIONS

This application claims priority to and incorporates by reference U.S. provisional patent application No. 63/594,419, filed Oct. 30, 2023.

### BACKGROUND

Systems to provide electrical bonding between conductors can be useful in a variety of contexts. In particular, an intersystem bonding termination can be used in different settings to provide various electrical systems with a connection to an earth ground (e.g., to ground telephone or cable lines). In some examples, an intersystem bonding termination can provide protection to electrical systems in the event of an overvoltage event, which may cause a difference in potential between devices within the electrical systems.

### SUMMARY

The present disclosure relates to electrical bonding, including with an intersystem bonding termination connector with improved operational performance and manufacturability.

In some aspects, the present disclosure can provide a grounding connector system for multiple conductors. The grounding connector system can include a connector that includes a connector body integrally formed from conductive material. The connector body can include a main bonding receptacle to receive a first conductor. A plurality of bonding receptacles can receive respective one or more second conductor to be in electrical connection with the first conductor via the connector body. Each of the plurality of the secondary bonding receptacles can include, respectively, a receptacle passage defined by a base wall, a top wall, and lateral sides walls that extend between the base and top walls, with a corresponding insertion direction for the one or more second conductors. The lateral side walls can taper outwardly in a direction transverse to the insertion direction, from a perspective moving from the base wall toward the top wall.

In some examples, for one or more of the secondary bonding receptacles, the base wall can define a circular side profile of the corresponding receptacle passage.

In some examples, one or more of the secondary bonding receptacles can include a screw port that extends through a substantially planar area of the top wall. The screw port can receive a corresponding fastener to secure the corresponding one or more second conductors.

In some examples, the screw port can be perpendicular to and extend through the substantially planar area. In some examples, the substantially planar area of the top wall can be wider than the screw port, in the direction transverse to the insertion direction.

In some examples, for one or more of the secondary bonding receptacles, the outward taper of the lateral side walls defines an angle of between 20 degrees and 40 degrees, inclusive.

In some examples, for the one or more of the secondary bonding receptacles, the outward taper of the lateral side walls defines an angle of about 30 degrees.

In some examples, the connector body can further include a rib that protrudes from the connector body to interconnect the plurality of secondary bonding receptacles.

In some examples, the grounding connector system can further include a cover that can be removeable securable to the connector body. The cover can include a first window and a second window. The connector body can further include a first tab at a first end and a second tab at a second end. The first and second tabs can be receivable in the first and second windows to secure the cover to the connector body.

In some examples, the cover can be selectively securable to the connector body with the first and second tabs in either a first orientation relative to the cover or a second orientation relative to the cover, different from the first orientation.

In some examples, the first window can be at a distal end of a first locking arm of the cover and the second window can be at a distal end of a second locking arm of the cover.

In some examples, one or more of the first or second locking arms can include a release tab protruding to the outside of the cover to receive a manual release force to release a corresponding one or more of the first or second tabs from the corresponding first or second window.

In some examples, the grounding connect system can also include a cover that can include an open base portion that receives the connector body to removably secure the cover to the connector body. The cover can further include a top portion that receives a top portion of the connector body and is narrower than the open base portion.

In some examples, the cover can include a set of ribs internal to the top portion. The set of ribs can be configured to contact the top portion of the connector to align the cover relative to the connector.

In some examples, the grounding connector system can further include an adapter. The adapter can include an adapter base and adapter portions that protrude in opposing directions at a first end of the adapter base to define adapter passages. The adapter can be securable to the connector to align the adapter passages with the main bonding receptacle to receive the first conductor.

In some examples, the adapter portions can be externally threaded.

In some examples, the adapter can be formed from composite material. The adapter can include a set of protrusions configured to be received into a corresponding set of apertures on the connector body to align the adapter passages with the main bonding receptacle.

In some aspects the present disclosure can provide a grounding connector system for multiple conductors. A connector can include a connector body. The connector body can include a main bonding receptacle that receives a first conductor. A secondary bonding receptacle can receive one or more second conductors to provide an electrical connection with the first conductor via the connector body. The secondary bonding receptacle can provide a receptacle passage and a corresponding insertion direction defined by a rounded base wall, a substantially planar top wall opposite the base wall and wider than the base wall traverse to the insertion direction, and lateral side walls. The lateral side walls can taper outwardly from the rounded base wall to the top wall. A port that extends through the connector body to the receptacle passage can receive a fastener to secure the one or more second conductors within the receptacle passage. An opening of the port into the receptacle passage can extend through and be surrounded by the substantially planar top wall to orient the fastener to be advanced into the receptacle passage toward the rounded base wall.

In some aspects, the present disclosure can provide a method of electrically connecting multiple conductors. A first conductor can be secured in a main bonding receptacle of an integrally formed conductive connector body. One or more second conductors can be inserted, respectively, into a receptacle passage of each secondary bonding receptacle of a plurality of secondary bonding receptacles of the connector body. Each of the plurality of the receptacle passages and respective insertion directions for the one or more conductors being defined by a base wall, a top wall, and lateral side walls of the corresponding secondary bonding receptacle. The lateral side walls can taper outwardly, in a direction transverse to the insertion direction, to widen the corresponding receptacle passage from a perspective moving from the base wall to the top wall. The respective one or more second conductors can be fastened within the corresponding secondary bonding receptacles by advancing screws through screw ports to urge the one or more second conductors towards the base walls of the secondary bonding receptacles. The plurality of screw ports can be on the top walls of the secondary bonding receptacles.

In some examples, the one or more conductors can be secured, respectively, in each of the plurality of secondary bonding receptacles. A plurality of conductors can be secured in at least one of the plurality of secondary bonding receptacles.

In some examples, an adapter can be attached to the connector body by inserting a set of protrusions of the adapter into a set of apertures on the connector body. A cover can be secured to the adapter by engaging a first window and a second window of the cover with a first tab and a second tab of the connector body, respectively.

### BRIEF DESCRIPTION OF THE DRAWINGS

The accompanying drawings, which are incorporated in and form a part of this specification, illustrate embodiments of the invention and, together with the description, serve to explain the principles of embodiments of the invention.

FIG. 1A is an isometric view of a connector, a cover, and a base assembled in accordance with the present disclosure.

FIG. 1B is an isometric view of the connector and cover of FIG. 1A.

FIG. 1C is an isometric view of the connector and base of FIG. 1A.

FIG. 1D is an isometric view of the connector of FIG. 1A.

FIG. 2A is a side elevation view of the connector body of FIG. 1A.

FIG. 2B is a top plan view of the connector body.

FIG. 2C is a bottom plan view of the connector body.

FIG. 2D is an enlarged partial view of part of a receptacle of the connector body.

FIG. 2E is a sectional view of the connector body, along a plane that bisects a screw port and corresponding conductor passage of the connector body.

FIGS. 3A through 3C are axonometric, top plan, and bottom plan views of the base of FIG. 1A.

FIG. 3D is a top axonometric view of the base and the connector of FIG. 1A.

FIG. 4A-4D are isometric, top plan, bottom plan, and side elevation views of the cover of FIG. 1A.

FIG. 4E is bottom axonometric view of the cover and the connector of FIG. 1A.

### DETAILED DESCRIPTION

Before any examples of the disclosed technology are explained in detail, it is to be understood that the disclosed technology is not limited in its application to the details of construction and the arrangement of components set forth in the following description or illustrated in the following drawings. The disclosed technology is capable of other implementations and of being practiced or of being carried out in various ways. Also, it is to be understood that the phraseology and terminology used herein is for the purpose of description and should not be regarded as limiting.

The following discussion is presented to enable a person skilled in the art to make and use examples of the disclosed technology. Various modifications to the illustrated examples will be readily apparent to those skilled in the art, and the generic principles herein can be applied to other examples and applications without departing from the disclosed technology. Thus, the disclosed technology are not intended to be limited to examples shown, but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of examples of the disclosed technology. Skilled artisans will recognize the examples provided herein have many useful alternatives that also fall within the scope of the disclosed technology.

As noted above, intersystem bonding termination can be used to connect various electrical systems to ground (or to otherwise electrically bond different conductors). Generally, a connector is used to provide attachment points for one or more conductors. These connectors can be manufactured using a variety of materials, including combinations of aluminum, bronze, and zinc, or various other metals. Various processes, including generally known casting processes, may be used to form the connector from the selected material.

Conventional designs for intersystem bonding termination connectors, and casting methods to produce those type connectors, may present various areas for improvement. For example, certain curved surfaces of conventional connectors can prevent (or at least complicate) the use of threaded cores during die casting, e.g., due to an increased risk of the casting material seeping into unwanted areas and the formed parts not releasing properly from the mold. Thus, a secondary coring process is often necessary to create threaded holes in the connector. Similarly, conventional connectors often include sections of various thicknesses in order to meet current carrying capacity requirements. During die casting (and other) processes, these sections of nonuniformed thickness may cause cracking or warping due to thermal stresses. Conventional designs may also generally employ more material than necessary, with corresponding inefficiencies relative to the ability of the connectors to carry appropriate current, secure conductors in place, or otherwise perform as desired.

Examples of the disclosed technology may provide an improved design for connectors, e.g., intersystem bonding termination connectors, including relative to ease of installation and reliability in service. Some examples can also address various issues associated with the die casting process used to manufacture the connector, including those identified above. For example, some configurations can address issues associated with the use of a threaded core by providing flat (e.g., planar or substantially planar) surfaces along select areas of a connector body. Accordingly, threaded holes may be possible without the need for secondary processing. Moreover, some implementations can provide for reduced material usage and more uniform material thickness throughout the part, without loss of strength or efficacy (e.g., relative to current carrying capacity to ground several electrical systems via several conductor connections).

Generally, a connector system may be used to ground or otherwise interconnect several electrical systems. In particular, examples herein may focus on intersystem grounding connectors, although the disclosed principles may also be applicable to other types of connectors.

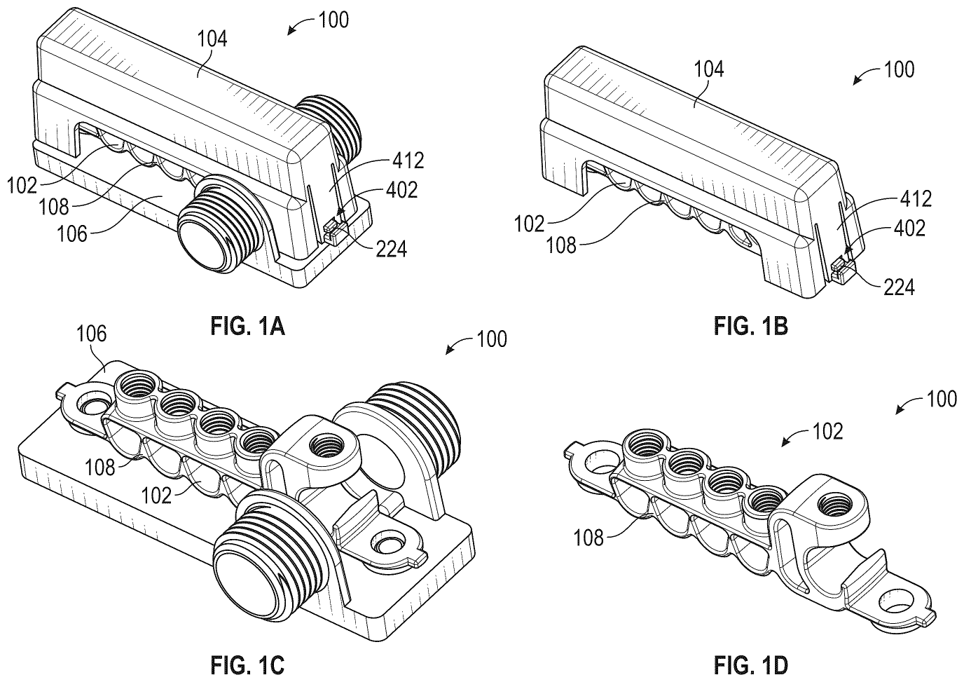

As one example, FIG. 1A illustrates a grounding connector system 100 that includes a connector 102, a cover 104, and an adapter 106. In some examples, the system may include only the connector 102 and the cover 104, only the connector 102 and the adapter 106, or only the connector 102, as shown in FIGS. 1B-1D, respectively.

The connector 102 includes a connector body 108 which may be integrally formed from a conductive material. In some examples, the connector body 108 may be integrally formed using a casting process. For example, the connector body 108 may be manufactured using a die casting process with alloys of zinc, aluminum, or copper.

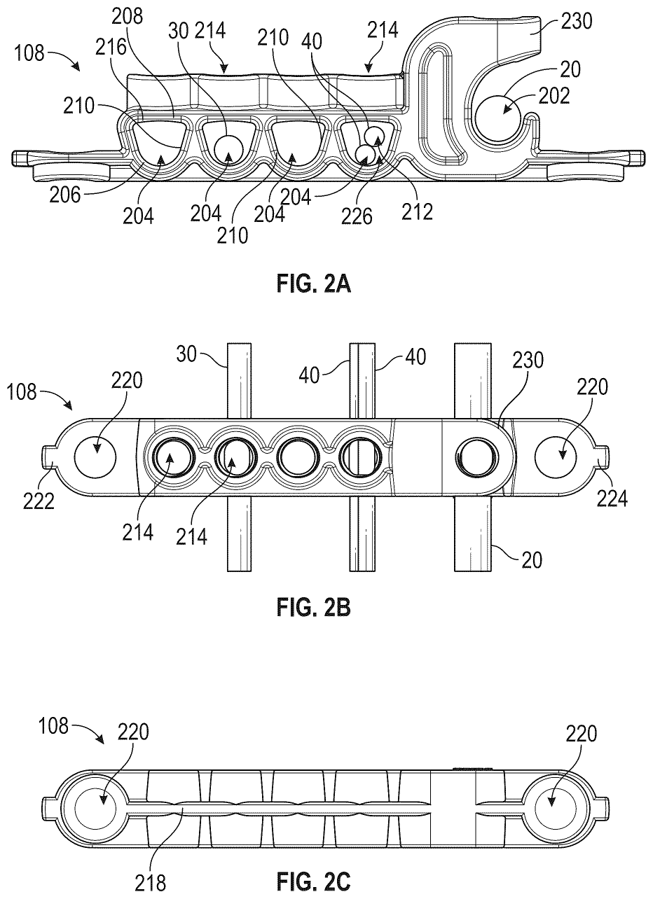

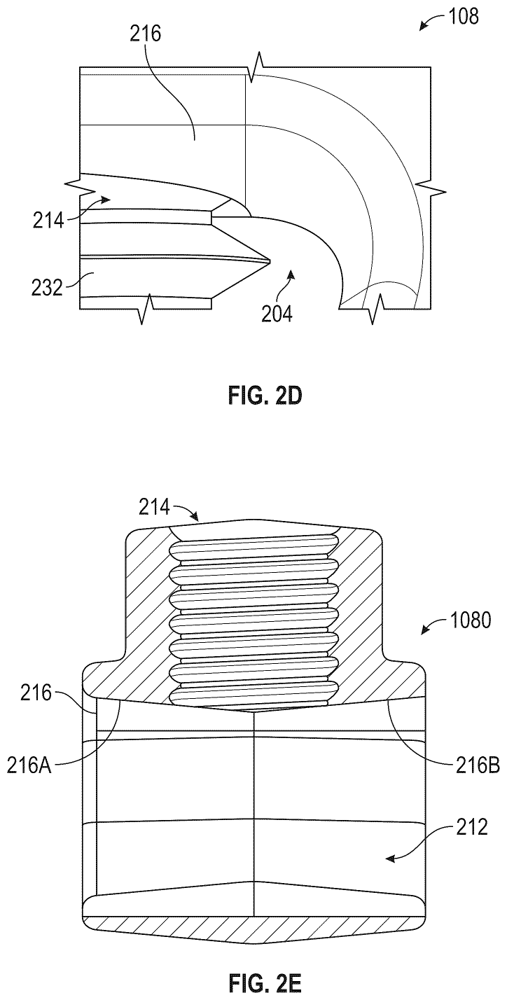

In some examples, the connector body 108 can include angled walls on conductor passages, selectively flattened surfaces, or other beneficial features (e.g., as also generally discussed above). In this regard, FIGS. 2A-2C illustrate an example configuration of the connector body 108 for use in the grounding connector system 100. In particular, the connector body 108 may include a main bonding receptacle 202 that is configured to receive a first conductor 20 (see FIG. 2A). For example, the first conductor can be a grounding conductor arranged to provide an electrical connection between the connector body 108 and the earth as an electrical ground. The connector body 108 may also include a plurality of secondary bonding receptacles 204 configured to receive one or more second conductors, and electrically connect them with the first conductor. In some examples, the second conductors can be grounding wires from various electrical device that are electrically interconnected with the first conductor to ground those electrical devices to earth. In some examples, the second conductors can be a stranded wire, a solid wire, a solid piece of conductive metal, a bus bar, etc.

As shown in FIG. 2A, the secondary bonding receptacles 204 are substantially identical to each other. Accordingly, unless otherwise noted, numbered features or description relative to one of the receptacles 204 also apply to others of the receptacles. In other examples, however, a connector may include secondary (or other) bonding receptacles of various or varied configurations.

In particular, in the example shown, each of the plurality of secondary bonding receptacles 204 includes a base wall 206, a top wall 208, and lateral side walls 210, which collectively define a receptacle passage 212. Each of the receptacle passages 212 can define a respective insertion direction for one or more of the second conductors, which may generally be substantially perpendicular to an elongate direction defined by the connector body 108 and substantially parallel to each other. In some examples, the base wall 206 may define a circular profile (i.e., may extend at least in part with a constant radius relative to a constant center point). For example, the surface of the base wall 206 may extend with a laterally symmetrical or otherwise aligned circular profile along an angular range of more than 90 degrees (e.g., 100 degrees or more, or 115 degrees or more) to provide particularly secure seating and retention for a conductor.

In some examples, the lateral side walls 210 of the secondary bonding receptacles 204 may taper outwards, in a direction transverse to the insertion direction of the receptacle. In particular, in the example shown, the side walls 210 can taper outwards relative to a perspective moving from the base wall 206 to the top wall 208 (i.e., can define a greater width of the receptacle 204, transverse to the insertion direction, with increasing distance from the base wall 206 toward the top wall 208). Correspondingly, the top wall 208 can be wider than the base wall 206, and the receptacle passage 212 may be asymmetrical with larger cross-sectional area in a top half thereof. In some examples, the angle at which the lateral side walls 210 taper outwards can be between about 20 degrees and about 40 degrees (e.g., about 30 degrees) to provide improved retention and easier installation with optimal material distribution and usage.

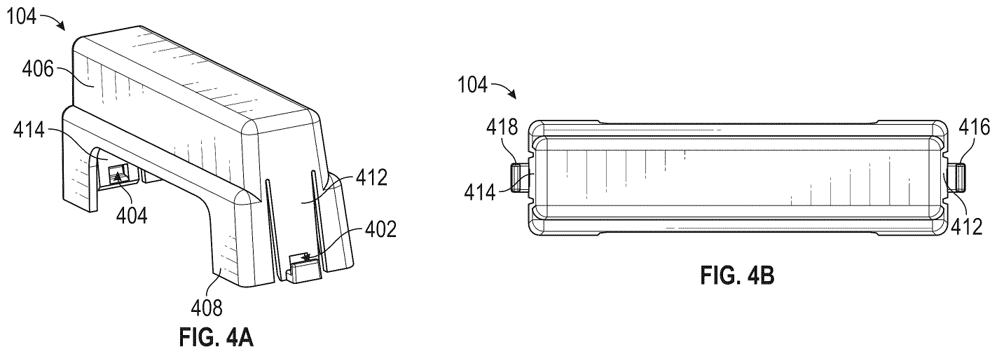

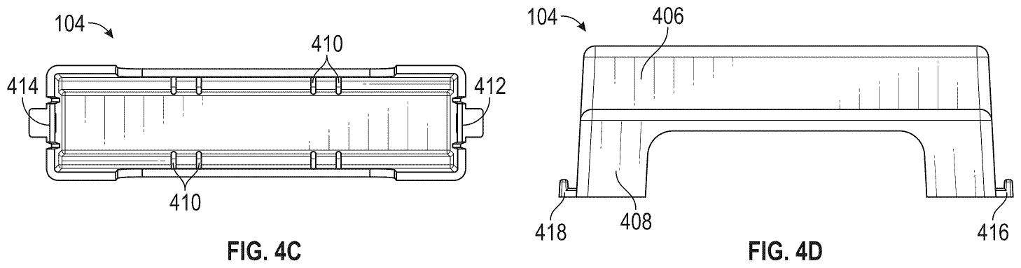

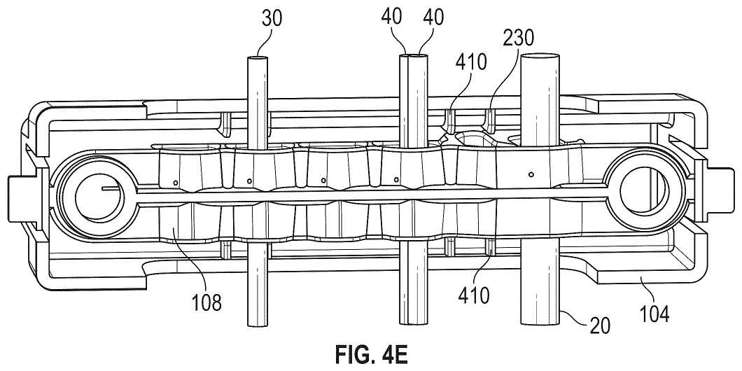

Generally, an outwardly tapering orientation of the side walls 210 can allow for easier insertion and anchoring of one or more conductors, and in some cases can help to better accommodate multiple conductors within a particular one of the receptacles 204. In some examples, the angle of the side walls 210 may be chosen so as to provide clearance for fuller advancement of an anchoring fastener into the receptacle 204 to selectively secure a conductor of a rated size or one or more smaller conductors (e.g., to be advanced to better secure a conductor of a radius smaller than the radius of a circular profile of the relevant bottom wall). For example, the side walls 210 in the illustrated example are tapered to meet the corresponding base wall 206 to define a lateral width that is at least equal to the diameter of a corresponding selected fastener that is used to secure the second conductor(s) that are inserted within the receptacle 204 (e.g., a fastener configured as set screw, as shown in FIG. 4). Such an angled configuration, for example, may help prevent the relevant fasteners from being over-limited in their advancement into the corresponding secondary bonding receptacles 204, while still ensuring secure clamping of the relevant conductor. As illustrated in FIG. 2A, the tapering of the side walls 210 may form a narrow end 226 at the base of the corresponding secondary bonding receptacle 204, including a smoothly curved transitions from the side walls 210 to the base wall 206. In other examples, however, other configurations are possible.

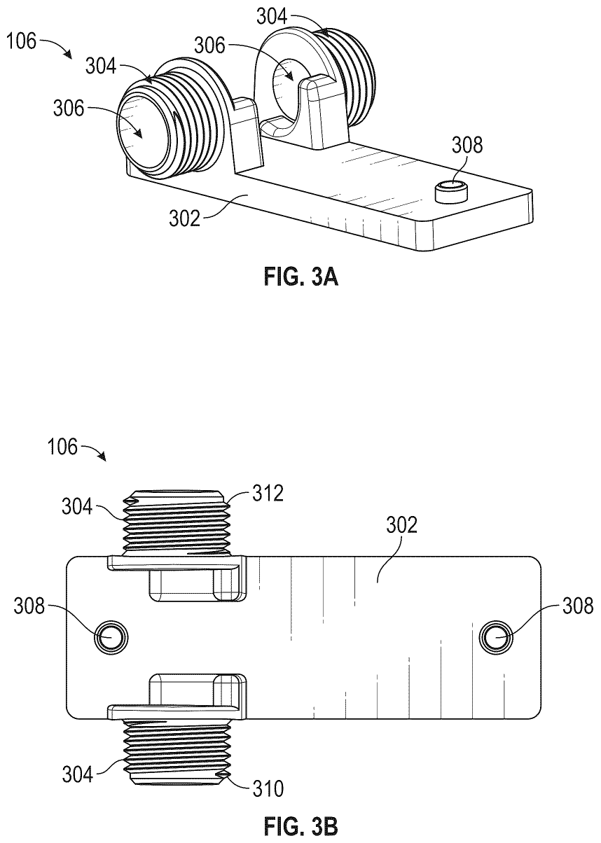

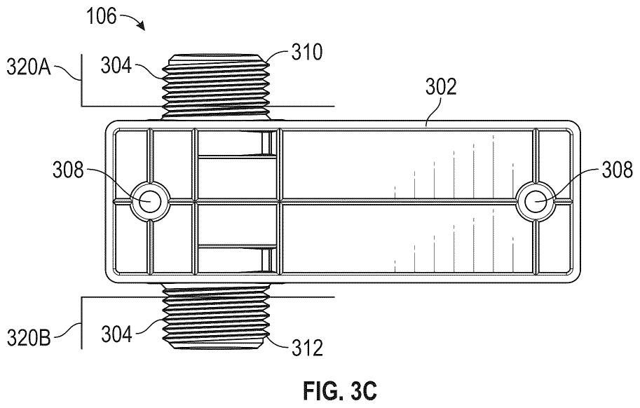

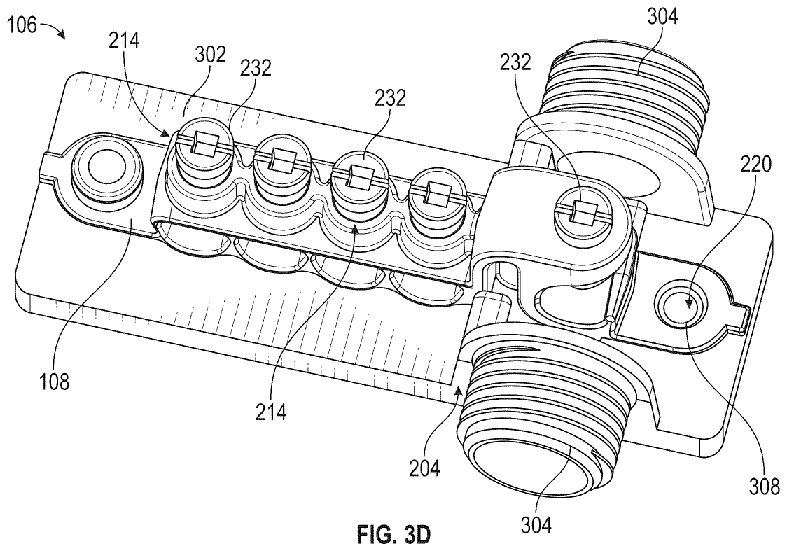

With particular reference to FIGS. 2A and 2B, in some examples, the plurality of secondary bonding receptacles 204 may include screw ports 214 to receive a corresponding fastener (e.g., a standard-sized set screw) that can be fastened to secure the corresponding one or more second conductors to the connector body 108 and within the relevant receptacle 204. A similar screw port 244 can be provided for the main bonding receptacle 202. Thus, for example, a main conductor 20 can be secured in the main bonding receptacle 202 and a secondary conductor 30 can be secured in one (e.g., any one) of the secondary bonding receptacles 204 (e.g., as secured by set screws, as shown in FIG. 3D). The particular diameter of the screw port 214 (and the corresponding set screw), in combination with the corresponding receptacle size and shape, can in some cases allow for multiple wires to be secured side-by-side (or otherwise) in one or more of the secondary bonding receptacles 204. In this regard, the outwardly tapered profile of the side walls 210 can also be relevant, with the increasing width of the passages 212 above the base walls 206 (see FIG. 2A) allowing for easier insertion, alignment, and securement of multiple conductors within a single receptacle 204. In some examples, the shape and size of the screw ports 214 and the passages 212 may be chosen to allow two number 10-gauge wires to fit simultaneously into each of the secondary bonding receptacles 204 (e.g., as shown with conductors 40 in FIGS. 2A and 2B). Accordingly, for example, the body 108 can allow a total of eight (or more) second conductors to be electrically connected to a first conductor received through the main receptacle 202.

Still referring to FIG. 2A in particular, the top walls 208 of the secondary bonding receptacles 204 may also include a planar area 216 (e.g., fully planar or substantially planar area). In some examples, the planar area 216 can include opposed substantially planar or fully planar surfaces 216A, 216B extending from a centerline or other separation line that intersects (e.g., bisects) the opening of the screw port 214 into the passage 212 (e.g., extending at draft angles of 5 degrees of less). In particular, the planar area 216 (e.g., each of the planar surfaces 216A, 216B) may be wider than the screw port 214, at an intersection between the screw port 214 and the passage 212, as shown in FIGS. 2A and 2D in particular. As well as ensuring easy and sufficiently extensive passage of a fastener 232 into the receptacles 204 (see, e.g., FIG. 2D), the planar area 216 having a width greater than the screw port 214 may allow a threaded core to be more easily and effectively used during the manufacturing process of the connector body 108. Accordingly, for example, inclusion of the planar area 216 can help to eliminate the need for secondary processing of the body 108 during manufacturing (e.g., to thread for the screw port 214).

In some examples, protrusions from a connector body can be provided in particular to balance reduced use of material with provision of sufficient material strength, thickness, and overall conductivity between particular sub-areas of the body. For example, as shown in FIG. 2C, the connector body 108 may include a rib 218, e.g., extending along a base side of the body 108. In particular, the rib 218 can provide increase material continuity between the secondary bonding receptacles 204 and the main receptacle 202, and thereby provide improved electrical interconnection between the secondary bonding receptacles 204 and the main receptacle 202. This, in turn, may result in more effective electrical interconnection for the system 100 overall, while still allowing reduction of overall material usage as compared to conventional designs. In some examples, the rib 218 can also (or additionally) provide a gate for material flow during casting of the connector body 108, during various manufacturing processes. Moreover, the size of the rib 218 may be adjusted in different examples to account for a particular desired current carrying capacity of the connector body 108. The rib 218 may be about 0.090 inches wide in some examples, to provide current carrying capacity corresponding to wires that are 6-gauge (or smaller) under the American Wire Gauge system.

In some embodiments, the grounding connector system may include an adapter that can be used to attach a connector body to another structural component (e.g., a building structure). FIGS. 3A-3C illustrate three views of an example configuration of the adapter 106 that can be used in the grounding connector system 100. In some examples, the adapter 106 is integrally formed from a composite material, such as a plastic material (e.g., polycarbonate). The adapter 106 may include an adapter base 302 and adapter portions 304 that can receive other components to assist in alignment or attachment of a first conductor into the main bonding receptacle 202 (see, e.g., FIG. 2A).

In particular, in the example shown, the adapter portions 304 protrude in opposing directions at a first end of the adapter base 302 to define adapter passages 306. In some examples, the adapter portions 304 are externally threaded. The externally threaded adapter portions 304 may allow the adapter 106 to be directly attached to a box or threaded conduit coupler. Because the adapter portions 304 protrude in opposing directions, the adapter 106 may be mounted to either side of a box without extending past the edge of the box, or with a threaded conduit coupler otherwise extending in either of two opposed directions for a particular elongate orientation of the adapter base 302 (and the system 100 overall). For example, when the adapter 106 is being mounted, an appropriate one of the threaded adapter portions 304 may be placed in a knock-out hole on either side of an electrical box and then secured therein (e.g., with a locknut). For example, as shown in FIG. 3C in particular, the adapter portions 304 may include a first threaded (or other) protrusion 310 and a second threaded (or other) protrusion 312 that are aligned axially with another, on opposing sides of the adapter 106. Thus, the adapter 106 can be selectively mounted on either sides of a box, via a corresponding one of the first protrusion 310 or the second protrusion 312, with corresponding shielding of the corresponding assembly by side walls of the box (e.g., as shown with example box locations 320A, 320B, partially illustrated in FIG. 3C).

As illustrated in FIG. 1C, the adapter 106 may be secured to the connector 102. In some examples, the adapter 106 may be secured to the connector 102 using screws or another form of fasteners (not shown) that can be received through apertures 220 on the connector body 108 and corresponding apertures on the adapter 106. In some examples, the adapter 106 may include a set of protrusions 308 (see, e.g., FIGS. 3A-3D). As shown in FIG. 3D in particular, the protrusions 308 can be received into the apertures 220 on the connector body 108 to help to both locate (e.g., stage) and then further secure the separate bodies together. Such an arrangement may be particularly beneficial, for example, to easily and reliably connect a composite adapter to a metal connector with appropriate security and alignment (e.g., with further security provided by a fastener that extends through the protrusion 308, as shown in FIG. 3D.

As also shown in FIG. 3D, multi-tool fasteners can be used in some examples to facilitate easier securement of conductors. In particular, in the illustrated example, the fasteners 232 are configured as set screws include combined square- and flat-head screwdriver structures, although other configurations are possible. Thus, for example, users may easily advance the fasteners 232 into the corresponding ports (e.g., ports 214) to secure corresponding conductors.

As also noted above, in some embodiments, the grounding connector system may include a cover. FIGS. 4A-4D illustrate four views of an example configuration of the cover 104 used in the grounding connector system 100. The cover 104 may be configured to removably secured to the connector body 108. In particular, the cover 104 may include a first window 402 and a second window 404, or more generally, first and second recesses. A first tab 222 and a second tab 224 of the connector body 108 can be received into the first and second windows 402, 404 to secure the cover to the connector body 108. Such a configuration may provide particularly ease of installation and removal, as further detailed below. However, in some examples, an inwardly protruding tab on a cover can instead (or alternatively) engage a corresponding recess (e.g., window or catch) formed on a connector body or other component.

The cover 104 exhibits certain symmetrical aspects, so that when the cover 104 can be secured to the connector body 108 using the first and second tabs 222, 224 with the cover 104 in either a first orientation or a second orientation, different from the first orientation (e.g., rotated 180o relative thereto). For example, for the illustrated configuration, in the first orientation, the first tab 222 may be received in the first window 402 (see, e.g., FIG. 1B), and the second tab 224 may be received in the second window 404. In contrast, in the second orientation, the first tab 222 may be received in the second window 404, and the second tab 224 may be received in the first window 402.

In some examples, one or more windows can be included on flexible arms of a cover, to further assist in easy and secure attachment (and detachment) of the cover to a connector. As further illustrated in FIG. 4A, for example, the first window and second window may be at a distal end of a first cantilevered locking arm 412 and a distal end of a second cantilevered locking arm 414, respectively. Thus, the locking arms 412, 414 can be resiliently flexed relative to the remainder of the cover 104 to engage with or disengage from the tabs 222, 224. The first and second locking arms 412, 414 may also include a first and second release tab 416, 418, respectively. The first and second release tabs 416, 418 may protrude to the outside of the cover 104 to provide easy manual engagement (e.g., directly or with hand tools) to release the tabs 222, 224 from the locking arms 412, 414 and thereby release the cover 104 from the connector 102. In particular, in some examples, the first and second release tabs may be moved (e.g., pried) away from one another introduce a moment that deflects the arms 412, 414 and thereby release the cover 104 from the connector body 108.

The cover 104 may also include a top portion 406 and an open base portion 408 which may receive the connector 102. As illustrated in FIG. 4A, in some examples the top portion 406 is narrower than the open based portion 408, e.g., internally to form an inward step along the interior of the cover 104 and also externally, as shown. The inward step may allow for material savings during the manufacturing process. For example, a PVC material may be used in an injection molding process to form the cover 104. The inward step may reduce the amount of PVC material used, in comparison to a cover having a uniform width between the top portion 406 and the open based portion 408. Moreover, when the cover 104 is placed on the connector body 108, the open based portion 408 may be configured extend relatively widely to better shield the connections made between the connector body 108 and the one or more second conductors. This wider configuration can assist both in protecting the connections from external factors and allowing easier visual inspection to assess the state of any given connection. Complementarily, the narrowed upper end of the cover can help to maintain appropriate alignment of the cover overall.

Relatedly, in some examples, the cover 104 also includes a set of ribs 410 internal to the top portion 406. The set of ribs 410 may be configured to contact the connector body 108 and align the cover 104 relative to the connector body 108. In particular, the ribs 410 can be spaced apart from the open based portion 408 so as only to engage with connector 102 along a protruding structure 230 that forms the main bonding receptacle 202 (see FIGS. 2A and 4E). Thus, the cover can be reliably aligned for securement via tactile feedback from engagement of the ribs 410 without the ribs 410 needing to protrude so far as to potentially interfere with conductors received into engagement with the connector body 108 (e.g., as shown in FIG. 4E).

In some examples, a cover may be used which contains markings within the internal surfaces of the top portion (e.g., as partly illustrated in FIG. 4D). The markings may, for example, include information identifying the torque limits of the fasteners used to secure the second conductors to the connector body for a particular product or product configuration.

The use herein of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In some implementations, devices or systems disclosed herein can be utilized, manufactured, installed, etc. using methods embodying aspects of the disclosed technology. Correspondingly, any description herein of particular features, capabilities, or intended purposes of a device or system should be considered to disclose, as examples of the disclosed technology a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, should be understood to disclose, as examples of the disclosed technology, the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Unless otherwise specified or limited, the terms “about” and “approximately,” as used herein with respect to a reference value, refer to variations from the reference value of ±20% or less (e.g., ±15, ±10%, ±5%, etc.), inclusive of the endpoints of the range. Similarly, as used herein with respect to a reference value, the term “substantially equal” (and the like) refers to variations from the reference value of less than ±5% (e.g., ±2%, ±1%, ±0.5%) inclusive. Where specified in particular, “substantially” can indicate a variation in one numerical direction relative to a reference value. For example, the term “substantially less” than a reference value (and the like) indicates a value that is reduced from the reference value by 30% or more (e.g., 35%, 40%, 50%, 65%, 80%), and the term “substantially more” than a reference value (and the like) indicates a value that is increased from the reference value by 30% or more (e.g., 35%, 40%, 50%, 65%, 80%).

Also as used herein, unless otherwise limited or specified, “substantially identical” refers to two or more components or systems that are manufactured according to the same process and specification, with variation between the components or systems that are within the limitations of acceptable tolerances for the relevant process or specification. For example, two components can be considered to be substantially identical if the components are manufactured according to the same standardized manufacturing steps, with the same materials, and within the same acceptable dimensional tolerances (e.g., as specified for a particular process or product).

Also as used herein, unless otherwise defined or limited, directional terms are used for convenience of reference for discussion of particular figures or examples or to indicate spatial relationships relative to particular other components or context, but are not intended to indicate absolute orientation. For example, references to downward, forward, or other directions, or to top, rear, or other positions (or features) may be used to discuss aspects of a particular example or figure, but do not necessarily require similar orientation or geometry in all installations or configurations.

Also as used herein, unless otherwise limited or defined, “substantially parallel” indicates a direction that is within ±12 degrees of a reference direction (e.g., within ±6 degrees or ±3 degrees), inclusive. Correspondingly, “substantially vertical” indicates a direction that is substantially parallel to the vertical direction, as defined relative to the reference system (e.g., a local direction of gravity, by default), with a similarly derived meaning for “substantially horizontal” (relative to the horizontal direction). Also as used herein, unless otherwise limited or defined, “substantially perpendicular” indicates a direction that is within ±12 degrees of perpendicular a reference direction (e.g., within ±6 degrees or ±3 degrees), inclusive. Similarly, “substantially planar” indicates a surface that extends along a reference plane with a mean deviation from the reference plane of less than 2.5 degrees over an entire areal extent of the surface, i.e., as measured by determining the largest angular deviation of a tangent line from the reference plane at each point on the surface, and determining the mean of those values for all points on the surface.

The previous description of the disclosed examples is provided to enable any person skilled in the art to make or use the disclosed technology. Various modifications to these examples will be readily apparent to those skilled in the art, and the generic principles defined herein may be applied to other examples without departing from the spirit or scope of the disclosed technology. Thus, the disclosed technology is not intended to be limited to the examples shown herein but is to be accorded the widest scope consistent with the principles and novel features disclosed herein.

1. A grounding connector system for multiple conductors, the grounding connector system comprising:
a connector that includes a connector body integrally formed from conductive material;
the connector body including:
a main bonding receptacle to receive a first conductor; and
a plurality of secondary bonding receptacles to receive respective one or more second conductors to be in electrical connection with the first conductor via the connector body;
each of the plurality of the secondary bonding receptacles including, respectively a receptacle passage defined by a base wall, a top wall, and lateral side walls that extend between the base and top walls, with a corresponding insertion direction for the one or more second conductors, the lateral side walls tapering outwardly in a direction transverse to the insertion direction, from a perspective moving from the base wall toward the top wall.

2. The grounding connector system of claim 1, wherein, for one or more of the secondary bonding receptacles, the base wall defines a circular side profile of the corresponding receptacle passage.

3. The grounding connector system of claim 1, wherein one or more of the secondary bonding receptacles include a screw port that extends through a substantially planar area of the top wall to receive a corresponding fastener to secure the corresponding one or more second conductors.

4. The grounding connector system of claim 3, wherein the substantially planar area of the top wall is wider than the screw port, in the direction transverse to the insertion direction.

5. The grounding connector system of claim 1, wherein, for one or more of the secondary bonding receptacles, the outward taper of the lateral side walls defines an angle of between 20 degrees and 40 degrees, inclusive.

6. The grounding connector system of claim 5, wherein, for the one or more of the secondary bonding receptacles, the outward taper of the lateral side walls defines an angle of about 30 degrees.

7. The grounding connector system of claim 1, wherein the connector body further includes a rib that protrudes from the connector body to interconnect the plurality of secondary bonding receptacles.

8. The grounding connector system of claim 1, further comprising:
a cover that is removably securable to the connector body, the cover including a first window and a second window;
wherein the connector body further includes a first tab at a first end and a second tab at a second end, the first and second tabs being receivable in the first and second windows to secure the cover to the connector body.

9. The grounding connector system of claim 8, wherein the cover is selectively securable to the connector body with the first and second tabs in either of a first orientation relative to the cover or a second orientation relative to the cover, different from the first orientation.

10. The grounding connector system of claim 8, wherein the first window is at a distal end of a first locking arm of the cover and the second window is at a distal end of a second locking arm of the cover.

11. The grounding connector system of claim 10, wherein one or more of the first or second locking arms include a release tab protruding to the outside of the cover to receive a manual release force to release a corresponding one or more of the first or second tabs from the corresponding first or second window.

12. The grounding connector system of claim 1, further comprising:
a cover that includes an open base portion that receives the connector body to removably secure the cover to the connector body; and
wherein the cover further includes a top portion that receives a top portion of the connector body and is narrower than the open base portion.

13. The grounding connector system of claim 12, wherein the cover includes a set of ribs internal to a top portion, the set of ribs being configured to contact the top portion of the connector to align the cover relative to the connector.

14. The grounding connector system of claim 1, further comprising:
an adapter including an adapter base and adapter portions that protrude in opposing directions at a first end of the adapter base to define adapter passages;
the adapter being securable to the connector to align the adapter passages with the main bonding receptacle to receive the first conductor.

15. The grounding connector system of claim 14, wherein the adapter portions are externally threaded.

16. The grounding connector system of claim 15, wherein the adapter is formed from composite material and includes a set of protrusions configured to be received into a corresponding set of apertures on the connector body to align the adapter passages with the main bonding receptacle.

17. A grounding connector system for multiple conductors, the grounding connector system comprising:
a connector that includes a connector body, the connector body including:
a main bonding receptacle that receives a first conductor;
a secondary bonding receptacle that receives one or more second conductors to provide an electrical connection with the first conductor via the connector body, the secondary bonding receptacle providing a receptacle passage and a corresponding insertion direction defined by:
a rounded base wall;
a substantially planar top wall opposite the base wall and wider than the base wall transverse to the insertion direction; and
lateral side walls that taper outwardly from the rounded base wall to the top wall; and
a port that extends through the connector body to the receptacle passage to receive a fastener to secure the one or more second conductors within the receptacle passage, an opening of the port into the receptacle passage extending through and being surrounded by the substantially planar top wall to orient the fastener to be advanced into the receptacle passage toward the rounded base wall.

18. A method of electrically connecting multiple conductors, the method comprising:
securing a first conductor in a main bonding receptacle of an integrally formed conductive connector body;
inserting one or more second conductors, respectively, into a receptacle passage of each secondary bonding receptacle of a plurality of secondary bonding receptacles of the connector body, each of the receptacle passages and respective insertion directions for the one or more conductors being defined by: a base wall, a top wall, and lateral side walls of the corresponding secondary bonding receptacle, with the lateral side walls tapering outwardly in a direction transverse to the insertion direction, to widen the corresponding receptacle passage from a perspective moving from the base wall to the top wall; and
fastening the respective one or more second conductors to the connector body within the corresponding secondary bonding receptacles by advancing screws through screw ports on the top walls of the secondary bonding receptacles to urge the one or more second conductors towards the base walls of the secondary bonding receptacles.

19. The method of claim 18, wherein securing the one or more conductors includes advancing at least one of the screws to secure a plurality of conductors in at least one secondary bonding receptacle of the plurality of secondary bonding receptacles.

20. The method of claim 18, further comprising:
attaching an adapter to the connector body by inserting a set of protrusions of the adapter into a set of apertures on the connector body; and
securing a cover to the adapter by engaging a first window and a second window of the cover with a first tab and a second tab of the connector body, respectively.
